(19) United States
(12) Patent Application Publication
(10) Pub. No.: US 2005/0268131 A1
(43) Pub. Date: Dec. 1, 2005

(54) Portable information terminal device

(76) Inventor: Yutaka Matsunobu, Hitachiota (JP)

Correspondence Address: MCDERMOTT WILL & EMERY LLP, 600 13TH STREET, N.W., WASHINGTON, DC, 20005-3096, US

(21) Appl. No.: 10/902,254

(22) Filed: Jul. 30, 2004

(30) Foreign Application Priority Data
Mar. 31, 2004 (JP) 2004-102495

(51) Int. Cl. G06F 1/30

(52) U.S. Cl. 713/323

(57) ABSTRACT

A portable information terminal device capable of preventing an opportunity of using a high-priority function from being missed by battery run-down. The device has multiple processors each for performing multiple functions, a power supply controller for detecting a residual quantity of battery energy from a battery and an external power supply and then controlling supply of electric power to the multiple processors, and a controller; the controller calculating a threshold of the battery energy capacity required for processing of information on a required function of the multiple functions, changing the threshold according to a particular priority level of the required function in the multiple functions, and notifying the power supply controller of a new threshold generated by the change, and the power supply controller controlling supply of the power to the multiple processors in accordance with the new threshold.

### CLAIM OF PRIORITY

The present application claims priority from Japanese application serial No. 2004-102496, filed on Mar. 31, 2004, the content of which is hereby incorporated by reference into this application.

### BACKGROUND OF THE INVENTION

The present invention relates to a battery-driven portable information terminal device employing a technique for preventing important functions from being made unusable by battery run-down.

In addition to a personal-information management function and a telephone communications function, recent portable information terminal devices that include hand-held telephones provided with advanced functions are provided with a variety of other added functions. These new functions range from a mail exchange function, a game-playing function, static camera image acquisition and dynamic image acquisition functions, a function for viewing photographic data and dynamic image data, a musical playback function, and other pleasure-like functions, to functions having a public nature, such as a function for viewing saved important information, and functions for storing and exchanging electronic account settlement data.

Portable information terminal devices are each driven by a battery, and in such a portable information terminal device driven by a battery, the provision of a greater number of further advanced functions is progressing. Battery energy consumption, however, varies significantly from function to function, and this makes it difficult for the user to understand the time for which the device can be used. Accordingly, more battery energy than estimated will be consumed, even if the user thinks that he/she has used the device only for a short time. As a result, there has been the problem that the user is placed in the situation where he/she is unable to use electronic account settlement or other important functions despite his/her intentions.

Therefore, a method for calculating the battery energy capacity necessary to ensure that a telephone communications function is reliably reserved for a fixed time, then comparing the thus-calculated necessary battery energy capacity and the current residual battery energy quantity while any other function is being used, and warning the user if continuing to use the device in excess of the necessary battery energy capacity is attempted, is proposed as a conventional technology for solving the problem mentioned above. The above technology is disclosed in, for example, Patent Document 1 (Japanese Patent Laid-Open No. 2001-352394).

The conventional technology described in Patent Document 1 mentioned above makes it possible, for example, for the user to previously set the action of a desired function, such as “wishing to place a telephone call for 5 minutes at least before the battery runs down”. Accordingly, the user can make the device first calculate the battery energy capacity required for the execution of the desired function, then provide a threshold for the current residual quantity of battery energy, and thus use other functions in order to limit the scheduling of actions that consumes more battery energy.

The use of other functions by the user, however, may result in a higher-priority new action schedule being added. In this case, it will become necessary, for example, for the user to modify existing settings for each scheduled action. For instance, if a download process using a communications function is performed to add electronic money information in the memory of the portable information terminal device, since the battery energy capacity required for the user to electronically pay the corresponding amount of electronic money will change, the need will arise to modify the setting of the threshold for the quantity of battery energy left.

However, the conventional technology described in Patent Document 1 has had the problems that the user must modify the existing settings for each action and thus that the device is disadvantageous in the ease of use. Electronic money payment and other electronic account settling functions are functions of high importance since, if the battery runs down and makes the device unusable, this will greatly inconvenience the user.

An object of the present invention is to provide a portable information terminal device capable of preventing an opportunity of using a high-priority function from being missed by battery run-down.

### SUMMARY OF THE INVENTION

In order to solve the above problems, the present invention provides a portable information terminal device comprises a plurality of processors each for performing a plurality of functions, a power supply controller for detecting a residual quantity of battery energy from a battery or an external power supply and for controlling supply of electric power to the above-mentioned plurality of processors, and a controller. In the portable information terminal device, the above-mentioned controller calculates a threshold of the battery energy capacity required for processing of information on a required function of the above-mentioned plural functions, changes the threshold according to a particular priority level of the required function in the plural functions, and notifies the above-mentioned power supply controller of a new threshold generated by the change. The power supply controller thus controls supply of power to the plurality of processors in accordance with the new threshold.

Thus, when a camera function or any other function of a low priority level is being used, the battery energy capacity required for data processing of an electronic account settling function of a high priority level can be reserved and deactivation (or the like) of the camera function can be limited automatically. Consequently, an opportunity of using a high-priority function can be prevented, with a higher probability than in the conventional method, from being missed by battery run-down. Also, a user is relieved from the trouble of paying careful attention to preventing an opportunity of using a high-priority function from being missed by battery run-down.

In addition, the foregoing threshold is changed automatically according to registered schedule data. Hence, the device can efficiently use up its battery energy without reserving the battery energy inadvertently for a function which, even if high in priority, is not planned to be used.

Furthermore, the foregoing threshold comprises a plurality of different thresholds, and when one of these thresholds is changed, each of other thresholds is also changed. This prevents settings of the other thresholds from being made invalid by the change of one threshold, thus always providing the user with an appropriate management function on battery residual energy.

Additionally, the foregoing threshold is changed automatically according to learning about a usage tendency of the user. This provides a user-oriented, appropriate management function on battery residual energy that allows for the time required for the user to process data on an electronic account settling function of a high priority level.

Furthermore, a threshold of the battery energy capacity required for processing of information on a desired function of the above-mentioned plural functions is changed by being selected from a setup screen. This allows the user to determine the threshold and to determine details of operational limitation as required.

In a further aspect of the present invention, the present invention provides a portable information terminal device comprising a plurality of processors each for performing a plurality of functions, a power supply controller for detecting a residual quantity of battery energy from a battery or an external power supply and for controlling supply of electric power to the above-mentioned plurality of processors, and a controller. In the portable information terminal device, the above-mentioned controller automatically changes, according to registered schedule data, a threshold of the battery energy capacity required for processing of information on a required function of the above-mentioned plural functions, and notifies the above-mentioned power supply controller of a new threshold generated by the change. The power supply controller thus controls supply of power to the plurality of processors in accordance with the new threshold.

Hence, the device can efficiently use up its battery energy without reserving the battery energy inadvertently for a function which, even if high in priority, is not planned to be used.

In a further aspect of the present invention, the present invention provides a portable information terminal device comprising a plurality of processors each for performing a plurality of functions, a power supply controller for detecting a residual quantity of battery energy from a battery or an external power supply and for controlling supply of electric power to the above-mentioned plurality of processors, and a controller. In the portable information terminal device, the above-mentioned controller changes, in accordance with selection from a setup screen, a threshold of the battery energy capacity required for processing of information on a required function of the above-mentioned plural functions, and notifies the above-mentioned power supply controller of a new threshold generated by the change. The power supply controller thus controls supply of power to the plurality of processors in accordance with the new threshold.

This allows the user to determine the threshold and to determine details of operational limitation as required.

According to the present invention, it is possible to obtain a portable information terminal device capable of preventing an opportunity of using a high-priority function from being missed by battery run-down.

### BRIEF DESCRIPTION OF THE DRAWINGS

FIG. 1 is a block diagram showing a portable information terminal device which is an embodiment of the present invention;

FIG. 2 is a block diagram showing the above-mentioned portable information terminal device when it is in a communications state;

FIG. 3 is a block diagram showing the above-mentioned portable information terminal device when it is in a camera image acquisition state;

FIG. 4 is a block diagram showing the above-mentioned portable information terminal device when it is in an infrared communications state;

FIG. 5 is a first flowchart showing the operation of the controller of FIG. 1;

FIGS. 6A and 6B are diagrams showing a first set of examples of threshold setup for operational limitation based on the quantity of battery energy left;

FIGS. 7A and 7B are diagrams showing a second set of examples of threshold setup for operational limitation based on the quantity of battery energy left;

FIG. 8 is a second flowchart showing the operation of the controller of FIG. 1;

FIG. 9 is a third flowchart showing the operation of the controller of FIG. 1;

FIG. 10 is a diagram showing a third example of threshold setup for operational limitation based on the quantity of battery energy left;

FIG. 11 is a first diagram explaining the consumption characteristics of battery energy;

FIGS. 12A and 12B are diagrams showing a fourth set of examples of threshold setup for operational limitation based on the quantity of battery energy left;

FIG. 13 is a second diagram explaining the consumption characteristics of battery energy;

FIGS. 14A and 14B are diagrams showing a fifth set of examples of threshold setup for operational limitation based on the quantity of battery energy left;

FIG. 15 is a third diagram explaining the consumption characteristics of battery energy;

FIG. 16 is a fourth flowchart showing the operation of the controller of FIG. 1;

FIG. 17 is a diagram showing a first example of a setup screen for setting, on a display panel 120 of FIG. 1, the threshold for operational limitation based on the quantity of battery energy left;

FIG. 18 is a diagram showing a second example of a setup screen for setting the threshold for operational limitation based on the quantity of battery energy left;

FIG. 19 is a diagram showing a third example of a setup screen for setting the threshold for operational limitation based on the quantity of battery energy left;

FIG. 20 is a diagram showing a fourth example of a setup screen for setting the threshold for operational limitation based on the quantity of battery energy left;

FIG. 21 is a diagram showing a fifth example of a setup screen for setting the threshold for operational limitation based on the quantity of battery energy left;

FIG. 22 is a diagram showing a sixth example of a setup screen for setting the threshold for operational limitation based on the quantity of battery energy left; and

FIG. 23 is a diagram showing a seventh example of a setup screen for setting the threshold for operational limitation based on the quantity of battery energy left.

### DESCRIPTION OF THE PREFERRED EMBODIMENTS

Embodiments of the present invention are described hereinafter.

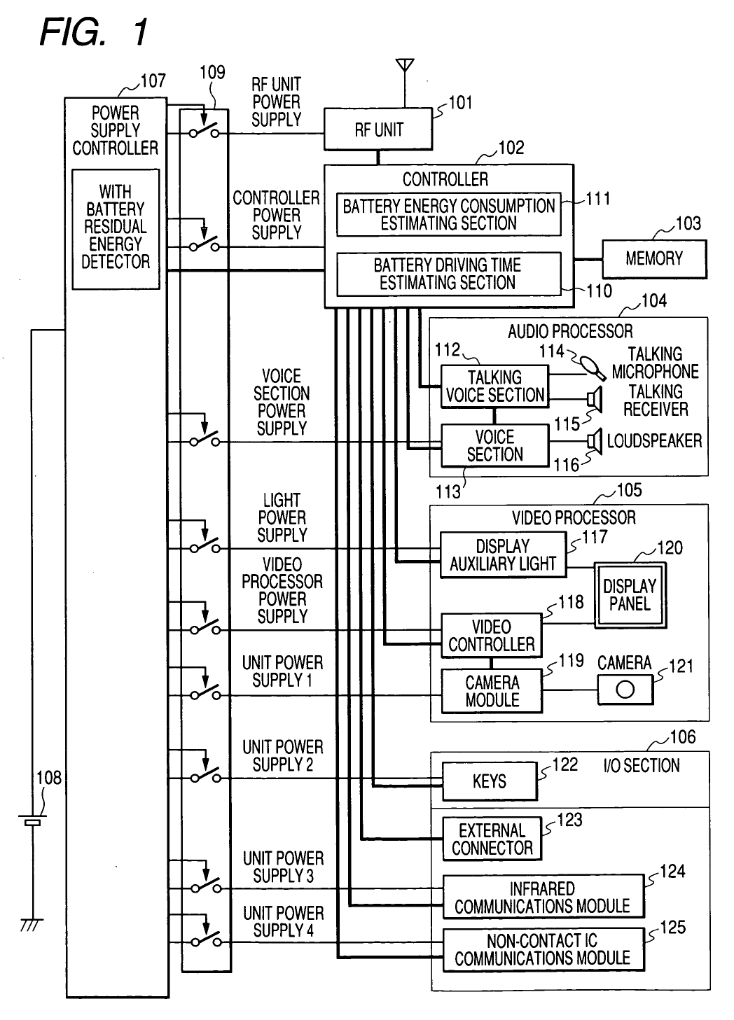

First, a configuration, and power control operation, of a portable information terminal device which is an embodiment of the present invention, are described below using FIGS. 1 to 4.

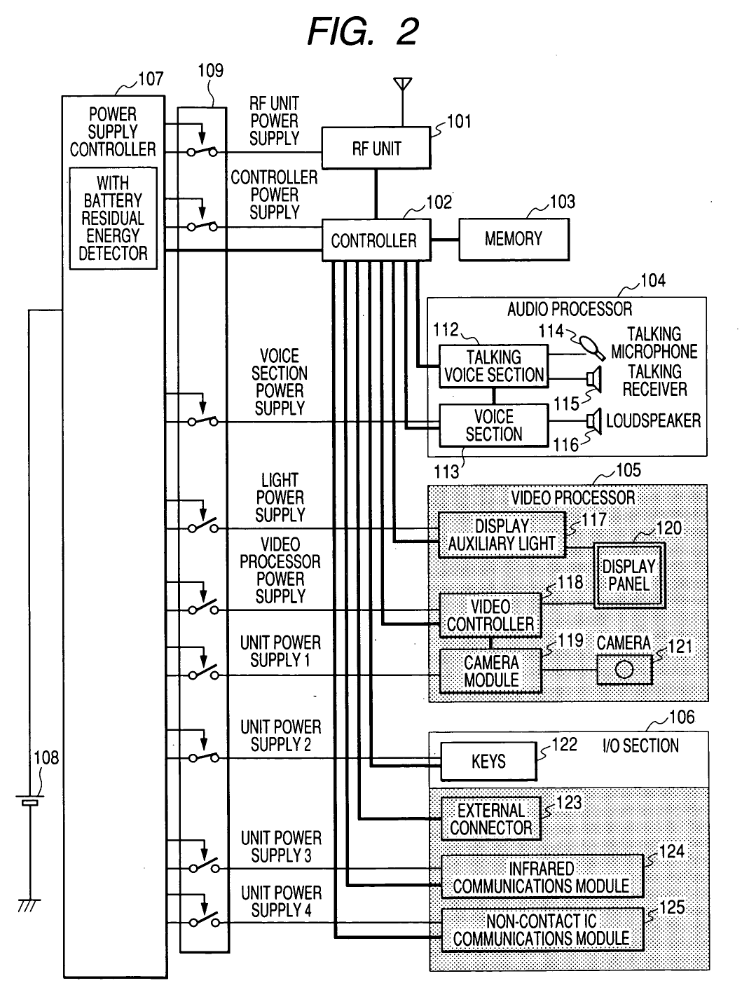

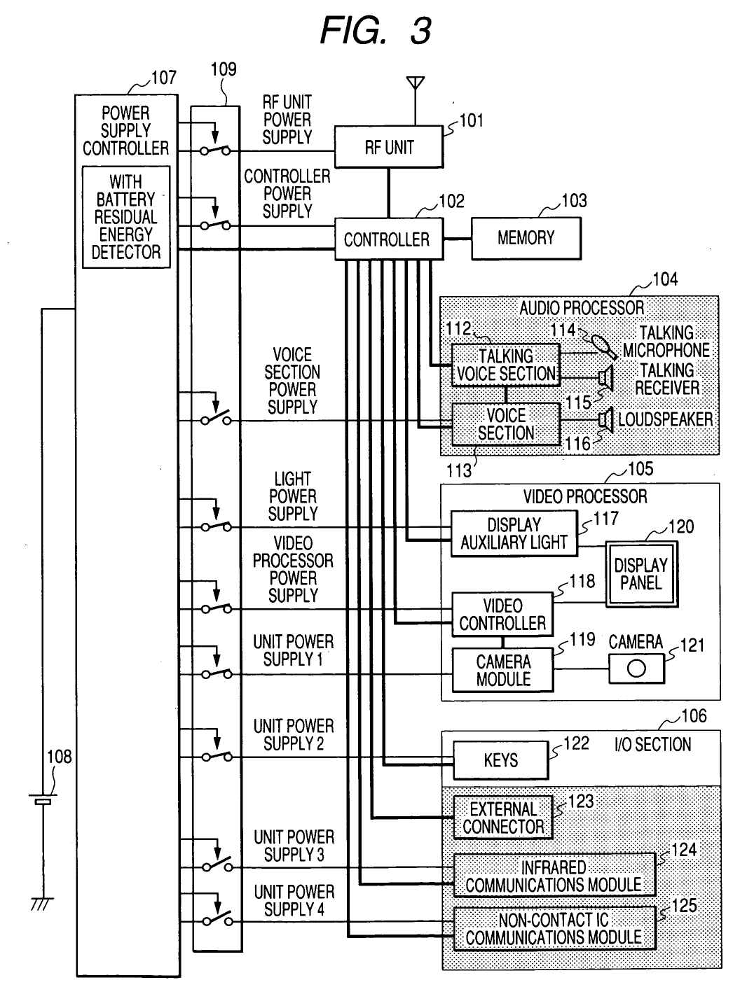

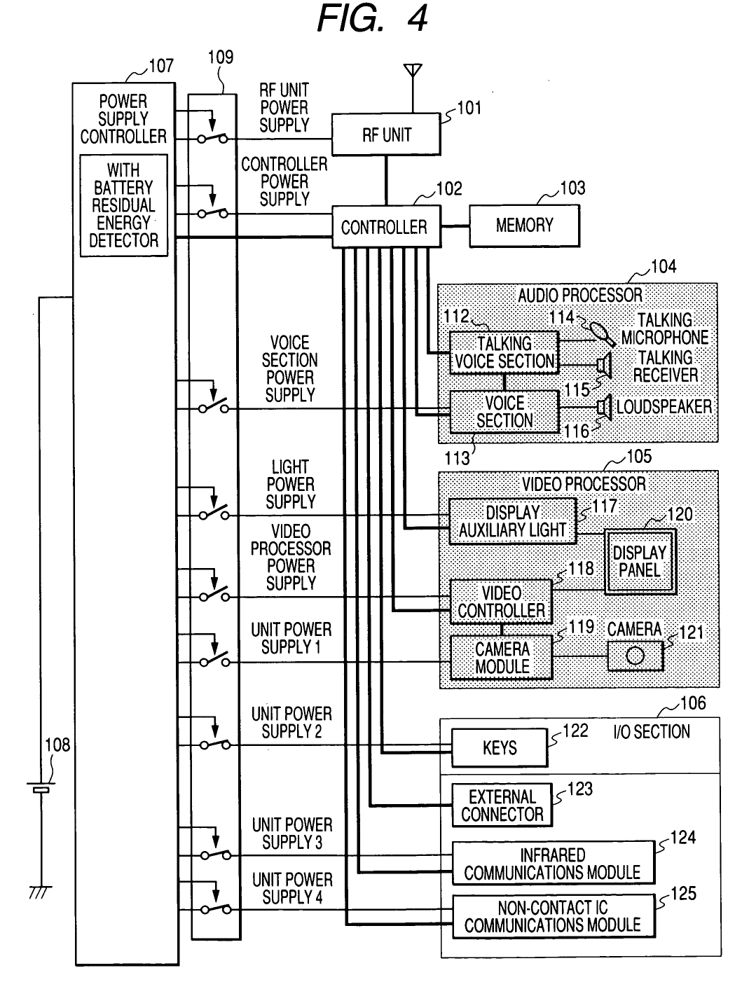

FIG. 1 is a block diagram showing a portable information terminal device that is an embodiment of the present invention. FIG. 2 is a block diagram showing the above-mentioned portable information terminal device when it is in a communications state. FIG. 3 is a block diagram showing the above-mentioned portable information terminal device when it is in a camera image acquisition state. FIG. 4 is a block diagram showing the above-mentioned portable information terminal device when it is in an infrared communications state.

The portable information terminal device according to present embodiment has an RF (radio-frequency) unit 101 of a wireless section for conducting wireless communications, a controller 102, and a memory 103 for storing user data in addition to control processing information on the controller 102. The portable information terminal device activates processors, namely, a voice processor 104, a video processor 105, and an I/O section 106, thus performing respective functions.

At this time, the device activates a power supply controller 107 to manage the electric power energy supplied from a single or multiple batteries 108 (hereinafter, referred to collectively as the battery 108) or an external power supply not shown. The power supply controller 107 has a battery residual energy quantity detector, and controls supply of power to the processors, namely, the voice processor 104, the video processor 105, and the I/O section 106, via power supply switches 109 according to a particular quantity of battery energy left.

The controller 102 activates a battery energy consumption estimating section 111 to calculate a threshold of the battery energy capacity required for processing of information on a desired function, one of multiple functions, then activates a battery driving time estimating section 110 to convert the threshold into a time, and notifies the power supply controller 107 of the time.

In accordance with the threshold notified of, the power supply controller 107 conducts control for optimal supply of power to the processors, namely, the voice processor 104, the video processor 105, and the I/O section 106, via the power supply switches 109.

In the portable information terminal device according to present embodiment, when a telephone communications function is performed, electric power energy is supplied from various power supplies via the power supply switches 109, as shown in FIG. 2. The power supplies here refer to a controller power supply (serving as a main power supply), an RF unit power supply (provided for wireless communications), a voice section power supply (provided for a talking voice section 112 that reproduces talking voices, and for a voice section 113), and a unit power supply 2 (provided for operation keys 122). Supply of the electric power energy to other circuits, except for the video processor 105 and the operation keys 122 of the I/O section 106, is stopped to suppress electric power energy consumption.

When a camera image acquisition function is performed, power is supplied from other power supplies via the power supply switches 109, as shown in FIG. 3. The power supplies here refer to a video processor power supply for a video controller 118 of the video processor 105, a unit power supply 1 for a camera module 119, and a light power supply for a display auxiliary light 117 provided for confirming camera-acquired images. Of the above elements, the display auxiliary light 117 may be supplied with or may not be supplied with power, depending on brightness of surroundings.

In addition, other circuit blocks are supplied with electric power energy, as the minimum power required, from the controller power supply (serving as the main power supply), the RF unit power supply for conducting periodic communications with wireless-network-connected apparatus to allow for call-receiving standby operation, and the unit power supply 2 for the operation keys 122. Supply of the electric power energy to other circuits, except for the voice processor 104 and the operation keys 122 of the I/O section 106, is stopped to suppress electric power energy consumption, except when effect sounds are to be generated.

When a process such as an electronic account settling process is performed using a local communications function such as infrared communication or non-contact IC communication, electric power energy is supplied from further other power supplies via the power supply switches 109, as shown in FIG. 4. The power supplies here refer to, in addition to a unit power supply 3 for an infrared communications module 124 or to a unit power supply 4 for a non-contact communications module 125, the controller power supply (serving as the main power supply), the RF unit power supply for conducting periodic communications with wireless-network-connected apparatus to allow for call-receiving standby operation, and the unit power supply 2 for the operation keys 122.

Supply of the electric power energy to other circuits, except for the voice processor 104 and the video processor 105, is stopped to suppress electric power energy consumption, except when effect sounds are to be generated. Furthermore, use is possible, even in a state where supply of power to the RF unit 101 is stopped so that almost no battery energy is consumed.

The states shown in FIGS. 1 to 4, in particular, are examples of states in which supply of power is controlled to ensure the minimum operation required. For improved convenience of the user, however, power may naturally be partly or temporarily supplied to operate the voice processor 104 and the video processor 105 in order to notify the progress of operation to the user in the form of panel display and/or a sound before and/or after the start of functions.

In this way, the power supply controller 107 conducts power management for each function, but a load applied to the battery 108 greatly differs for each function according to particular differences in consumption between circuit blocks. In particular, the amounts of loading by the RF unit 101 and the controller 102 during a communications process using the telephone communications function are significant. The amounts of loading by the camera module 119 and the video processor 108 during execution of the camera function are also significant.

However, when infrared communication, non-contact IC communication, or viewing only of the data saved within the memory 103 is executed, consumption of the electric power energy from each power supply is small. Electric power energy consumption by the controller 102 at that time is also small since the memory data is only read out intermittently. For these reasons, even when the RF unit 101 is powered off, there is no trouble with the execution itself of functions and the device can be operated. In this context, the load on the battery 108 is not significant.

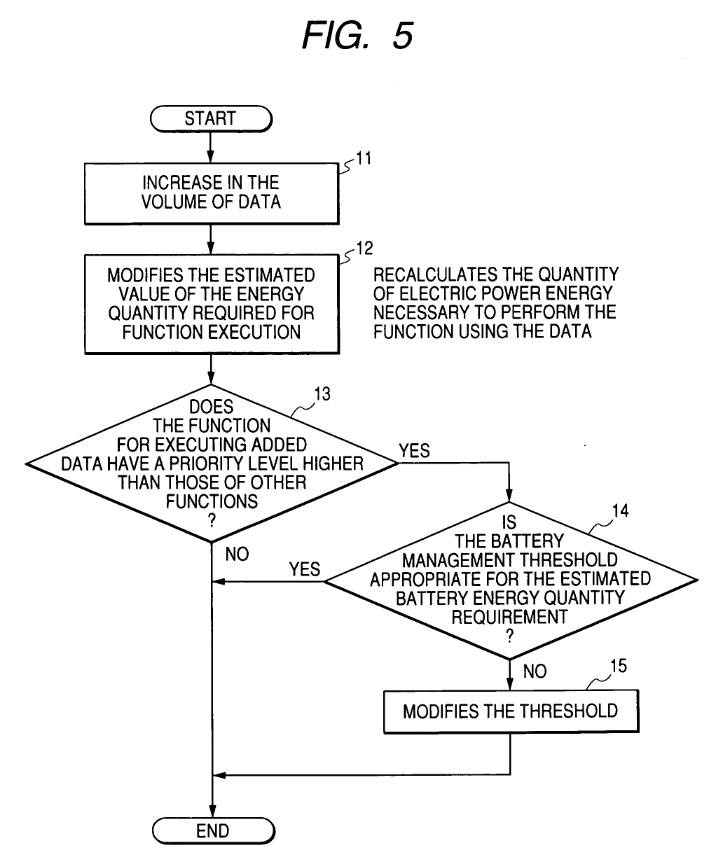

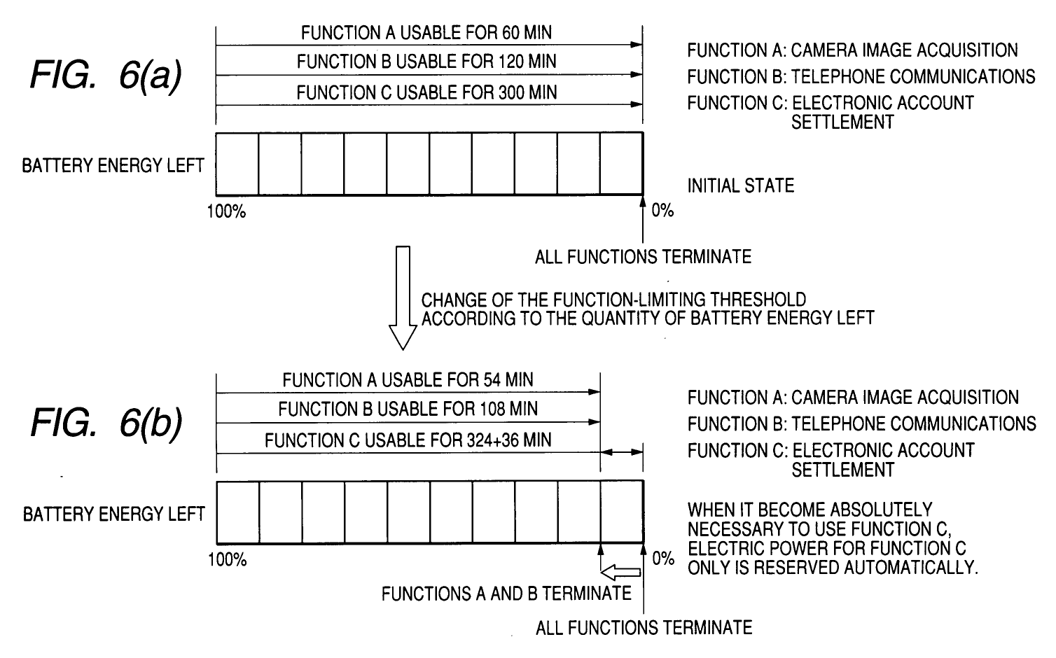

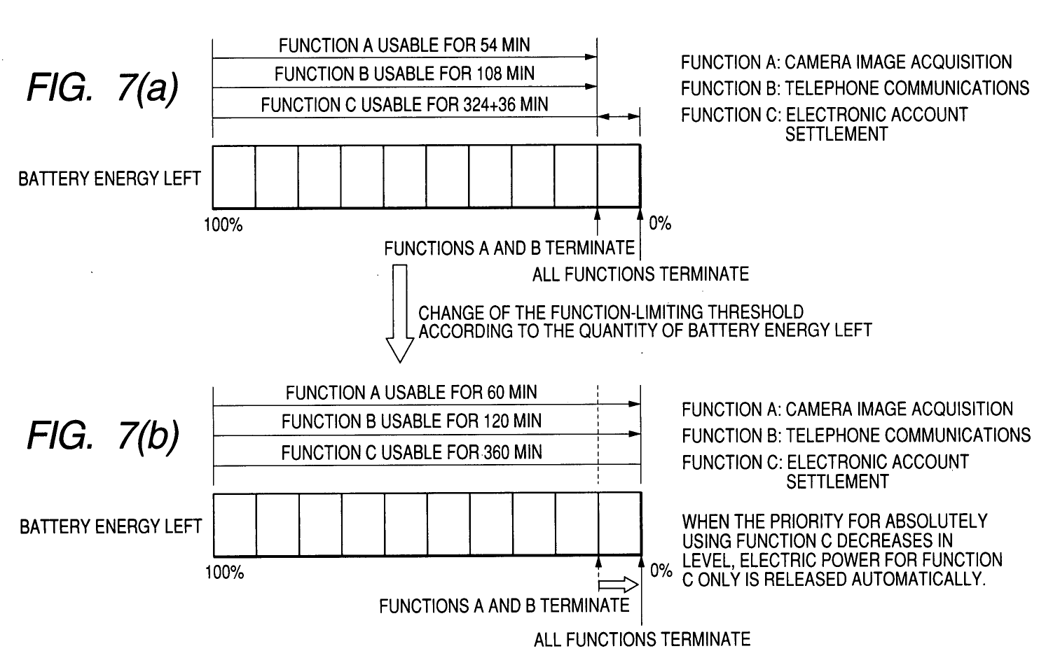

Next, examples of threshold setup for operational limitation based on the quantity of battery energy left are described below using FIGS. 5, 6A, 6B, 7A, and 7B. FIG. 5 is a first flowchart showing the operation of the controller 102 of FIG. 1. FIGS. 6A and 6B are diagrams showing a first set of examples of threshold setup for operational limitation based on the quantity of battery energy left. FIGS. 7A and 7B are diagrams showing a second set of examples of threshold setup for operational limitation based on the quantity of battery energy left.

Various functions of the portable information terminal device according to the present embodiment, i.e., the camera image acquisition function, the telephone communications function, and the electronic account settling function are defined as functions A, B, and C, respectively, as shown in FIG. 6. A method of reserving the battery energy capacity required for processing with the electronic account settling function is described below, with the electronic account settling function being taken as a function of high importance.

The present embodiment assumes that when the battery 108 operates at 600 mAh, the electric power energy consumed during the operation of each function is about 600 mA for dynamic camera image acquisition, about 300 mA for telephone communications, and about 100 for infrared communication. When current consumption differs for each function in this way, a usable time of each function also differs.

In an initial state, as shown in FIG. 6A, there is no difference (0%) between the functions in terms of the threshold for operational limitation based on the quantity of battery energy left, and all the above functions operate until the quantity of battery energy left has become 0%.

Here, when an amount is entered in an electronic money input field for electronic account settling function C, it is necessary to make the electronic money preferentially usable in whatever case.

In accordance with the entered amount, the battery energy consumption estimating section 111 within the controller 102 then calculates the necessary battery energy capacity from the quantity of electric power energy required for execution. After that, the threshold for operational limitation during use of functions A and B is changed to match the above-calculated battery energy capacity.

For example, if, as shown in FIG. 6B, the calculated battery energy capacity is equivalent to 10% of the quantity of electric power energy left, the threshold for operational limitation during use of functions A and B is 10%. Functions A and B stop operating when the threshold for operational limitation during use of functions A and B decreases below 10%.

In this way, the threshold for operational limitation based on the quantity of battery energy left is changed to automatically reserve an electric power energy quantitative requirement for electronic money of high importance. An opportunity of using a high-priority function can therefore be prevented from being missed by battery run-down.

A changing procedure on the threshold for operational limitation is set forth using the first operational flowchart of FIG. 5. In an initial state, there is no difference between the functions in terms of the threshold for operational limitation based on the quantity of battery energy left.

In step 11, data increases when electronic money or electronic ticket data is added in the portable information terminal device by execution of download processing with a communications function.

Next, in step 12, the necessary battery energy capacity to be reserved from the quantity of electric power energy required for execution of the data by use of the electronic account settling function is estimated arithmetically by the battery energy consumption estimating section 111 within the controller 102. The estimated battery energy quantitative requirement for function execution, stored in the memory 103 beforehand, is correspondingly changed.

In step 13, the added data is judged in terms of importance. If, as with electronic money data, the function using the data is recognized as high in importance and high in priority over any other functions, a threshold for battery management must be obtained so as to especially protect only the battery energy capacity required for the execution of that function.

In step 14, therefore, a comparison is conducted between the estimated battery energy capacity requirement last stored and the value obtained by the above change of the estimated quantity of battery energy required for function execution. If the value by the change of the estimated quantity of battery energy required for function execution is judged to be greater and use of that value is judged not to be appropriate, the threshold for operational limitation based on the quantity of battery energy left is changed in step 15. If no change is required, processing is terminated intact without the threshold being changed.

If, in step 13, the function is judged to be low in importance and thus low in priority, processing is terminated intact without a change made to the threshold for operational limitation based on the quantity of battery energy left.

In the portable information terminal device of the present embodiment, for example, when electronic money data is appropriately processed and this reduces the priority for the use of function C, the threshold for operational limitation based on the quantity of battery energy left is, as shown in FIG. 7, re-changed to the value existing before the threshold was changed in order that function A and function B can be conducted more.

In addition, the present embodiment assumes that the setting of the threshold for operational limitation based on the quantity of battery energy left is automatically changed to prevent inadvertent overuse by the user. However, when there is a time interval up to the planned usage date estimated, for example, from a valid term of an electronic ticket and it is easily estimated that the user will recharge the battery during that time interval, the setting of the threshold may not be immediately changed and this setting may be changed, for example, when the planned usage date is reached. As described above, timing of the setting change is likely to depend on a schedule of the user.

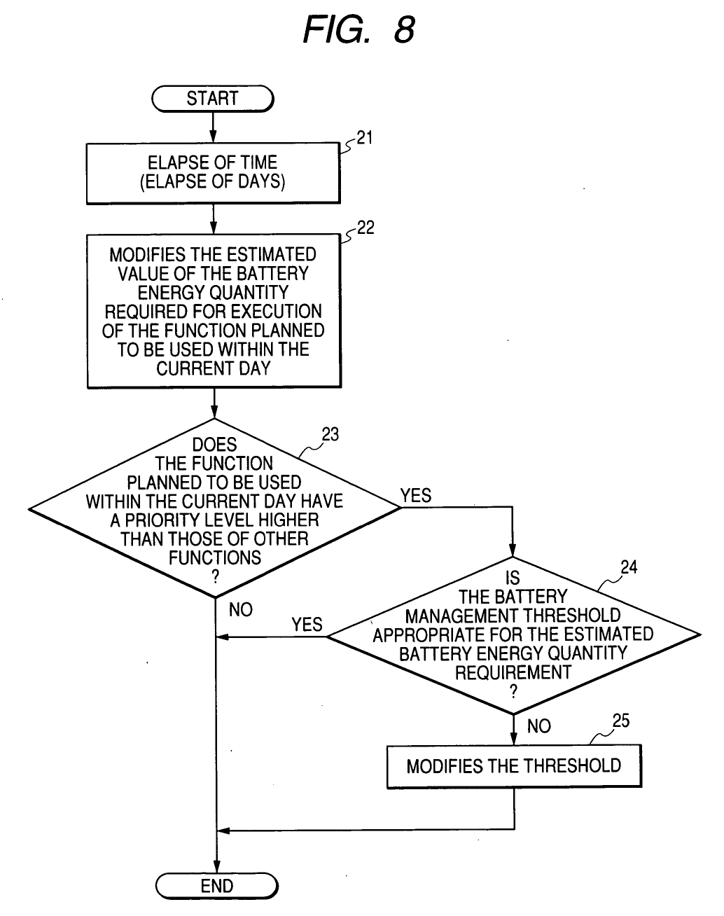

A second operational flowchart of the controller 102 of FIG. 1 at this time is shown in FIG. 8. This figure assumes that the battery is recharged each day. When electronic ticket data is downloaded and the amount of data increases, this makes it necessary to especially protect only the battery energy capacity required for use of the electronic ticket data.

However, since there is a time interval up to the planned usage date, this planned usage date is only registered as schedule data in the memory 103 and the threshold for operational limitation based on the quantity of battery energy left is not immediately changed.

After this, in step 21, an internal clock of the portable information terminal device advances as time elapses, and in step 22, the battery energy capacity required for the functions planned to be used within the current day is estimated from the schedule data by means of calculation. Based on the estimation, a modification is made to the value stored within the memory 103 as the estimated value of the battery energy capacity required for function execution.

Next, a judgment is conducted in step 23 to confirm whether the functions planned to be used within the current day include functions, such as electronic ticket data processing, that are likely to have importance higher than that of any other function.

If there is electronic ticket data or other data judgeable to use a function of higher importance than any other function, a judgment is conducted in step 24 to verify whether the battery energy capacity required for use of the electronic ticket data can be specially protected with the current battery management threshold remaining intact.

If the current threshold for battery management is insufficient for the necessary battery energy capacity that is to be reserved, the threshold for operational limitation based on the quantity of battery energy left is modified in step 25. Thus, only the battery energy capacity required for use of the electronic ticket data can be specially protected without the battery energy being used too much even during use of any other function.

When use of a service not available at purchase of the portable information terminal device is contracted for with a service-providing company and usage registration on that service is set in the device, the threshold for operational limitation based on the quantity of battery energy left is also changed.

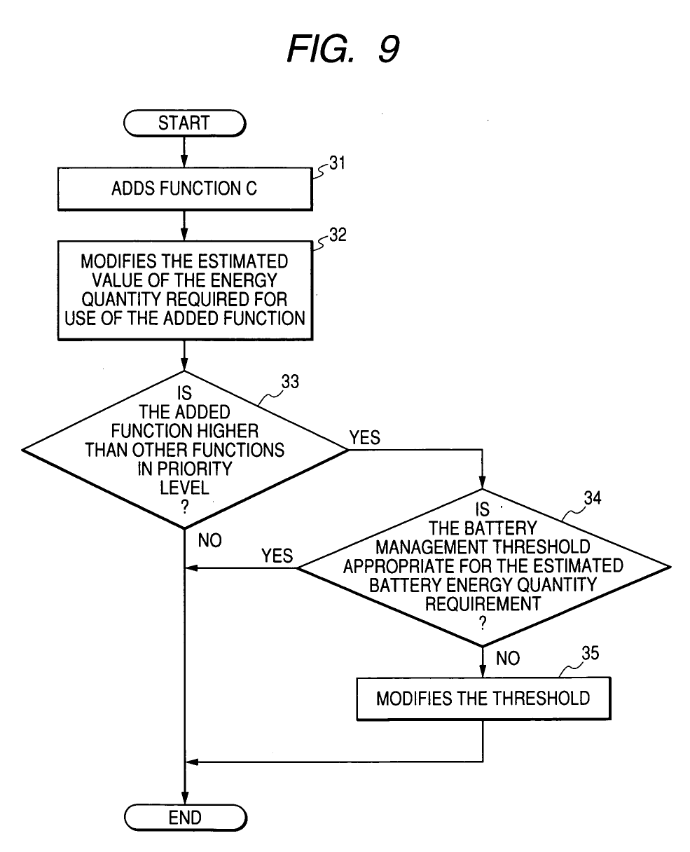

A third operational flowchart of the controller 102 of FIG. 1 at this time is shown in FIG. 9. This figure assumes that the portable information terminal device in an initial state has a telephone communications function and a communications function and that the communications function is utilized in such a manner that a mail server is accessed only to exchange mail data.

In step 31, function C for electronic account settlement is added to the portable information terminal device by adding electronic account settlement software to which is assigned a function that allows the software to conduct electronic account settlements by accessing a specific server capable of processing electronic account settlements and acquiring electronic money data.

Next, in step 32, the quantity of electric power energy required for the portable information terminal device to perform the electronic account settling function is estimated by calculation. The estimated battery energy quantitative requirement for function execution, stored in the memory 103, is correspondingly changed.

In step 33, a judgment is conducted to confirm whether the electronic account settling function is higher than telephone communications and mail exchange functions in terms of importance.

If the function is judgeable to be of higher priority, a judgment is further conducted in step 34 to verify whether the threshold for battery management, used to limit the operation of the telephone communications and mail exchange functions, is to be changed.

If, in step 34, the threshold for battery management is judged to require modification in order to especially protect the battery energy capacity required for the execution of electronic account settling function C, the threshold for operational limitation based on the quantity of battery energy left is changed in step 35.

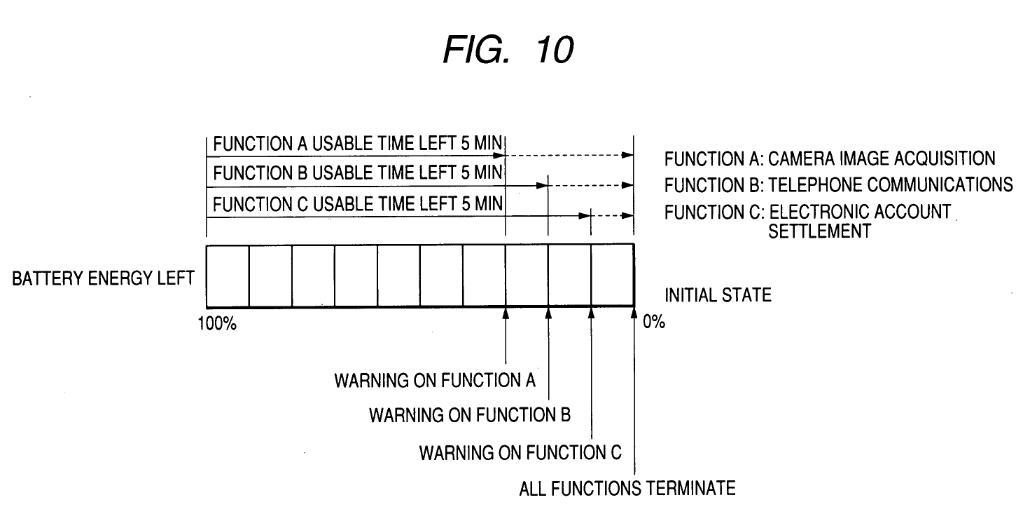

Next, impacts of a change to the battery management threshold for ensuring an opportunity of using the function prioritized, upon a battery-based usable time of other functions, are described below using FIGS. 10 to 15.

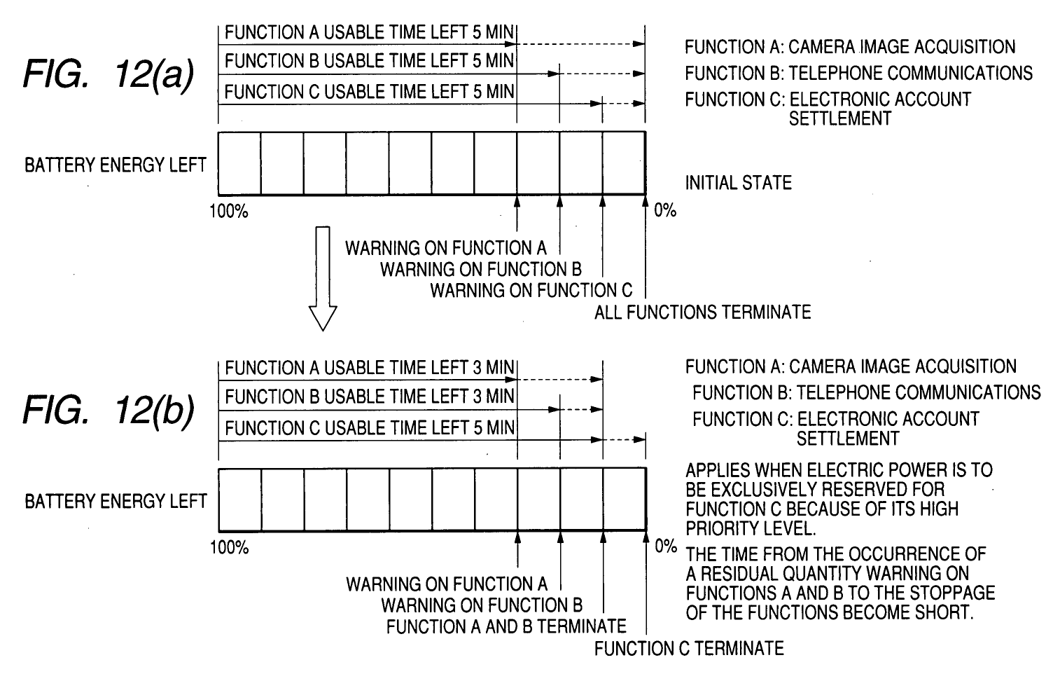

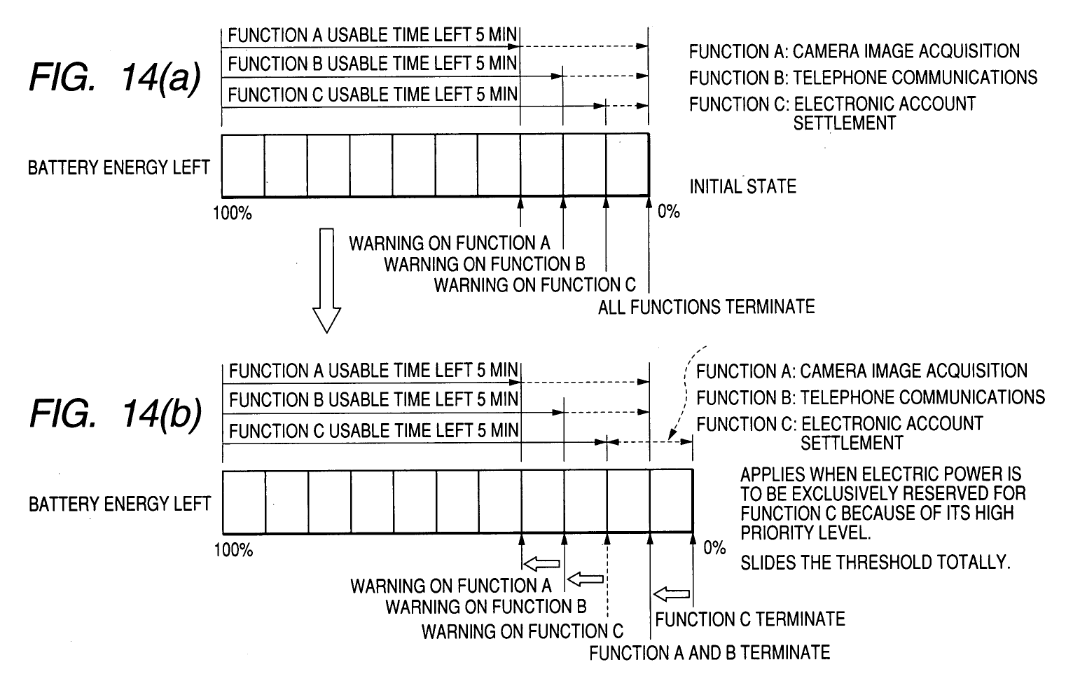

FIG. 10 is a diagram showing a third example of threshold setup for operational limitation based on the quantity of battery energy left. FIGS. 12A and 12B are diagrams showing a fourth set of examples of threshold setup for operational limitation based on the quantity of battery energy left. FIGS. 14A and 14B are diagrams showing a fifth set of examples of threshold setup for operational limitation based on the quantity of battery energy left. Each of FIGS. 10, 12A, 12B, 14A, and 14B is a schematic bar-graphic representation of a battery energy capacity with which typical functions can be used.

Each of FIGS. 10, 12A and 14A represents a state before the threshold for operational limitation based on the quantity of battery energy left is changed. Each of FIGS. 12B and 14B represents a state after the threshold is changed. These figures represent impacts of the changes to the threshold upon the battery-based usable time of typical functions.

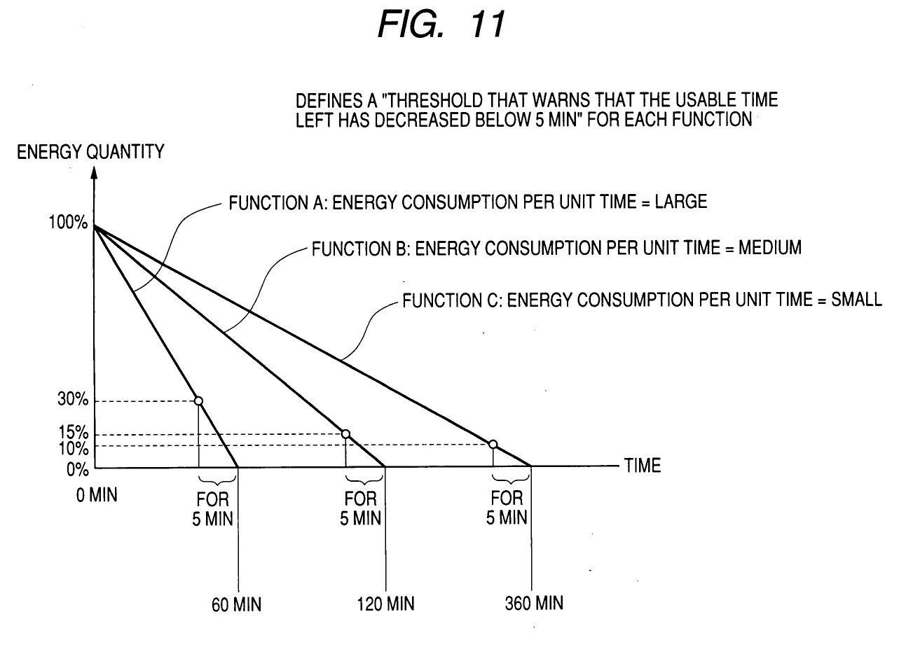

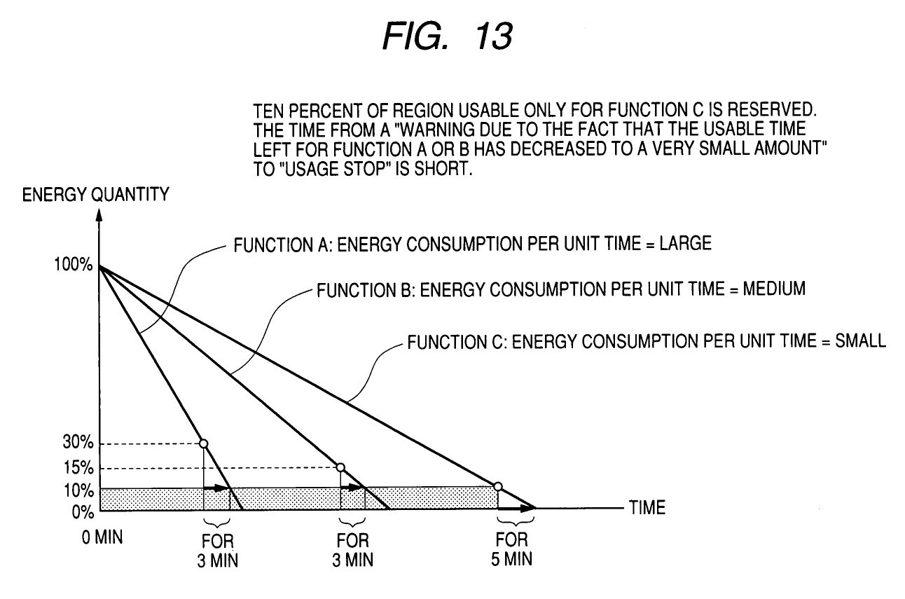

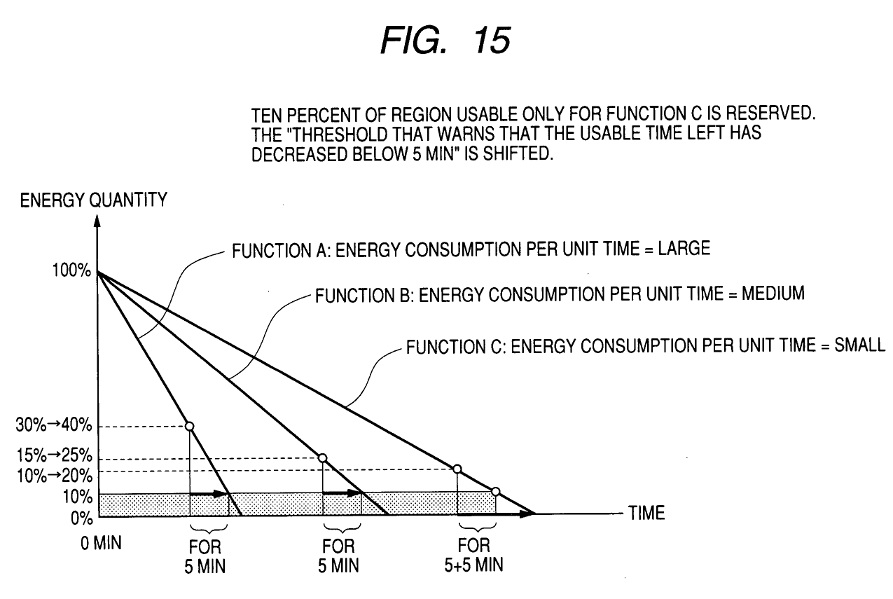

FIG. 11 is a first diagram that explains consumption characteristics of battery energy. FIG. 13 is a second diagram explaining the consumption characteristics of battery energy. FIG. 15 is a third diagram explaining the consumption characteristics of battery energy. In each of these three figures, changes in battery energy capacity are plotted on a vertical axis, a battery energy capacity of 0% is taken as an origin and the battery energy capacity increases as it goes further upward from the origin. The usable time left is plotted on a horizontal axis. A position of zero minutes is taken as an origin, and the usable time left increases in a rightward direction of the origin.

First, as in the example of the bar graph of FIG. 10, thresholds different for each function are set up, by way of example, in order of increasing magnitude of a load current so that a warning about the quantity of battery energy left is issued beforehand (this warning is referred to as the residual quantity warning). In this example, as in FIG. 11, changes in battery energy capacity are plotted on a vertical axis and the usable time left is taken on a horizontal axis. It can be confirmed that the quantity of battery energy left when the usable time left becomes five minutes for each function is not constant.

That is, if a definition is intentionally conducted, as in FIG. 11, in order for the residual quantity warning to be issued when a usable time of the battery energy becomes a fixed time (e.g., five minutes), a threshold at which operational limitation of each function becomes valid in proportion to energy consumption per unit time of the function necessarily varies from function to function, as shown in FIG. 10.

In this case, if the thresholds for functions A and B are both changed to 10% to reserve, as shown in FIGS. 12B and 13, a battery energy capacity with which only function C of high importance can be used, the time from the occurrence of the residual quantity warning for functions A and B to operational deactivation thereof decreases to three minutes, which is too short.

From the viewpoint of maintaining a fixed remaining usage time for functions A and B, therefore, threshold settings are preferably slid totally as shown in FIGS. 14B and 15.

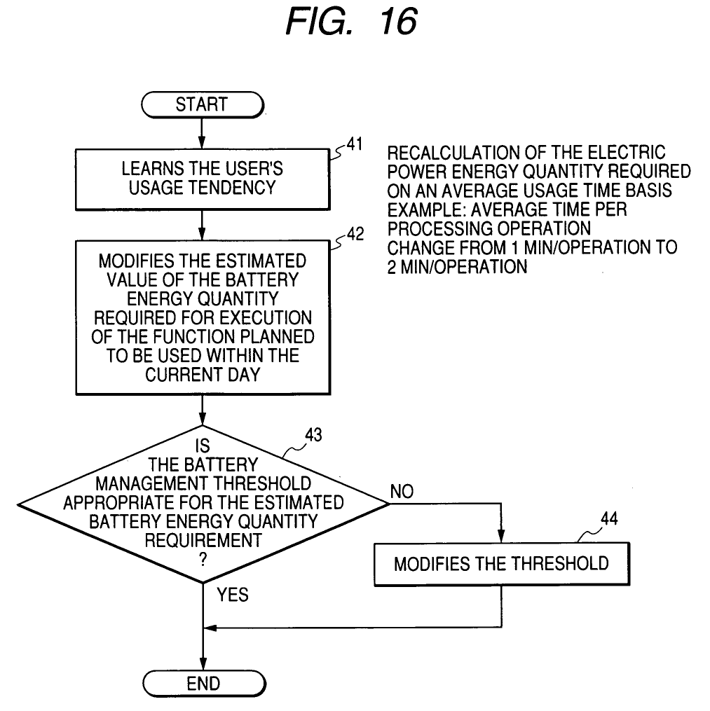

Furthermore, during, for example, electronic account settlement processing requires a long average time per processing operation, when a learning function detects that the time required for viewing a usage result history after the processing operation has been performed is long, it is judged that a function usage opportunity must be ensured over a longer time. As a result, the threshold for operational limitation based on the quantity of battery energy left is changed in accordance with such operational flowchart 4 of the controller 102 of FIG. 1 as shown in FIG. 16.

The portable information terminal device in an initial state assumes that, for example, when a device usage time for execution of electronic account settlement processing is defined as “1 min/operation”, and the minimum number of usage opportunities guaranteed for electronic account settlement processing, as five, the battery energy needed to ensure a usage time of five minutes for the five opportunities is defined as 5%. In the initial state, when the quantity of battery energy left becomes 5%, the use of each function is limited so that only the electronic account settling function can be used.

In step 41, for example, if learning is conducted so that a function usage pattern of the user is averaged, the above definition of the device usage time for execution of electronic account settlement processing is changed from “1 min/operation” to “12 min/operation”.

In next step 42, even when the minimum number of usage opportunities guaranteed for electronic account settlement processing remains unchanged from five, the need arises to ensure a usage time of 10 minutes for the five opportunities, the above definition of an estimated value of the battery energy capacity to be reserved is changed from the initial 5% to 10%.

In next step 43, it is judged whether the threshold for operational limitation of other functions, based on the quantity of battery energy left, is to be modified to ensure an opportunity for the use of electronic account settling function C when the quantity of battery energy left decreases.

If it is judged that the threshold for battery management must be modified to specially protect only the battery energy capacity required for the execution of electronic account settling function C, the threshold for operational limitation based on the quantity of battery energy left is changed in step 44.

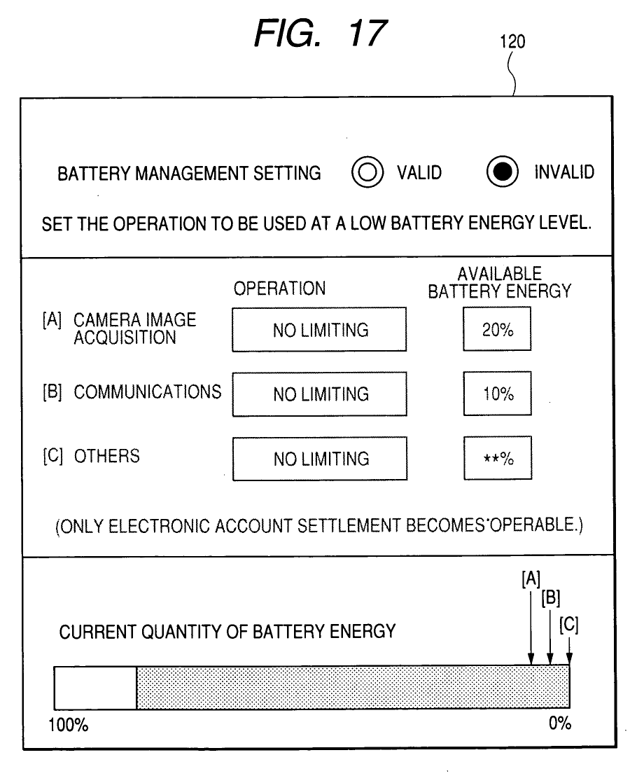

Next, examples of an operations screen for battery management threshold setting are shown in FIGS. 17 to 23.

FIG. 17 is a diagram showing a first example of a setup screen for setting, on a display panel 120 of FIG. 1, the threshold for operational limitation based on the quantity of battery energy left. Whether the setting itself is to be made valid or invalid can be selected using a check box shown at the top of the screen.

If “Invalid” is ticked as in FIG. 17, a details setup section in a middle row of the screen is displayed in a pale color. The fact that the setting is invalid, therefore, can be visually identified at once. Also, the quantity of battery energy left is displayed on a meter at the bottom of the screen and thus, the state existing when the setting operation was performed can be readily identified.

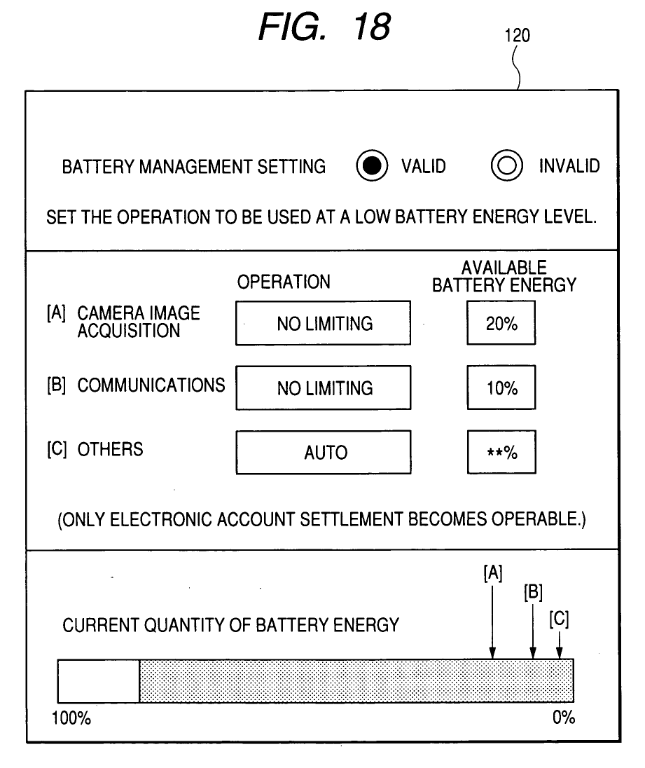

FIG. 18 is a diagram showing a second example of a setup screen for setting the threshold for operational limitation based on the quantity of battery energy left. The screen shown in FIG. 18 is an example on which the threshold for operational limitation based on the quantity of battery energy left is settable, in other words, made valid.

In this example, operational limitations on the camera image acquisition function, the communications function, and the electronic account settling function, can be set in detail. The thresholds for operational limitation of the respective functions are explicitly shown on the meter indicating the quantity of battery energy left, at the bottom of the screen.

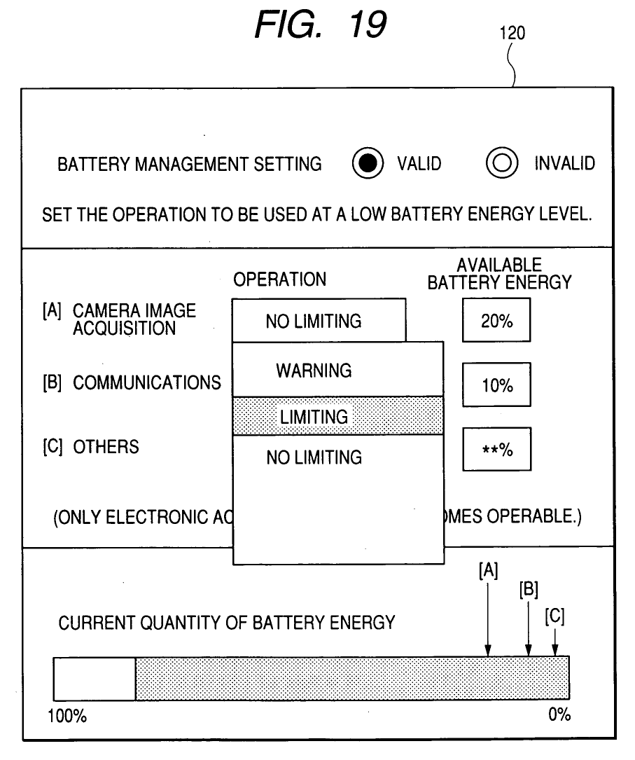

FIG. 19 is a diagram showing a third example of a setup screen for setting the threshold for operational limitation based on the quantity of battery energy left. In this example, after clicking “Limiting” for the operation of the camera function, whether “Warning” to the user, “Limiting”, or “No limiting” is to be made valid when the quantity of battery energy left equals the threshold set can be selected by clicking the corresponding characters.

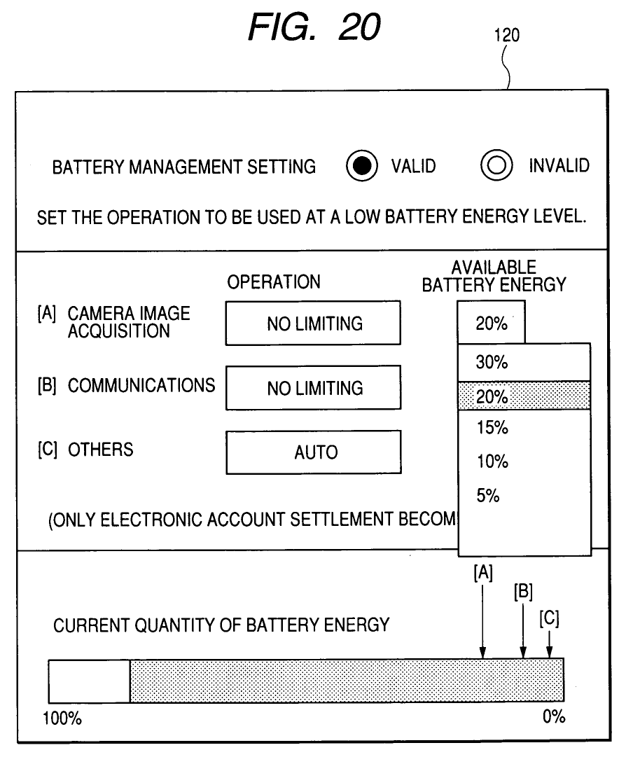

FIG. 20 is a diagram showing a fourth example of a setup screen for setting the threshold for operational limitation based on the quantity of battery energy left. In this example, after clicking a residual battery energy quantity of “20%” for the camera function, whether “30%, “20%”, “10%”, or “5%” is to be made valid can be selected by clicking the corresponding characters.

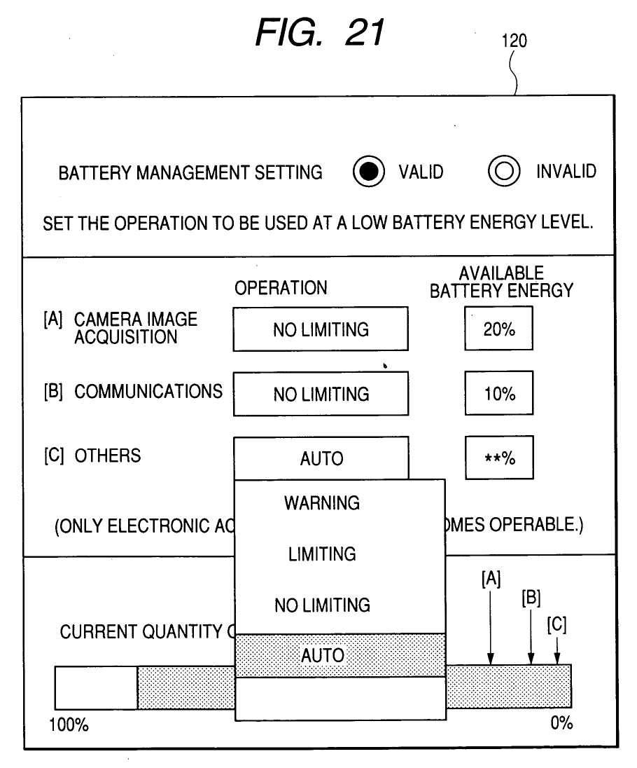

FIG. 21 is a diagram showing a fifth example of a setup screen for setting the threshold for operational limitation based on the quantity of battery energy left. In this example, if “Auto” is clicked, when data for electronic account settlement is saved in the device, the operation of the function item “Others” (other than the camera function and the communications function) is limited to reserve the quantity of battery energy left for execution of the electronic account settling function. The quantity of battery energy left for execution of the electronic account settling function changes according to the threshold saved in the portable information terminal device.

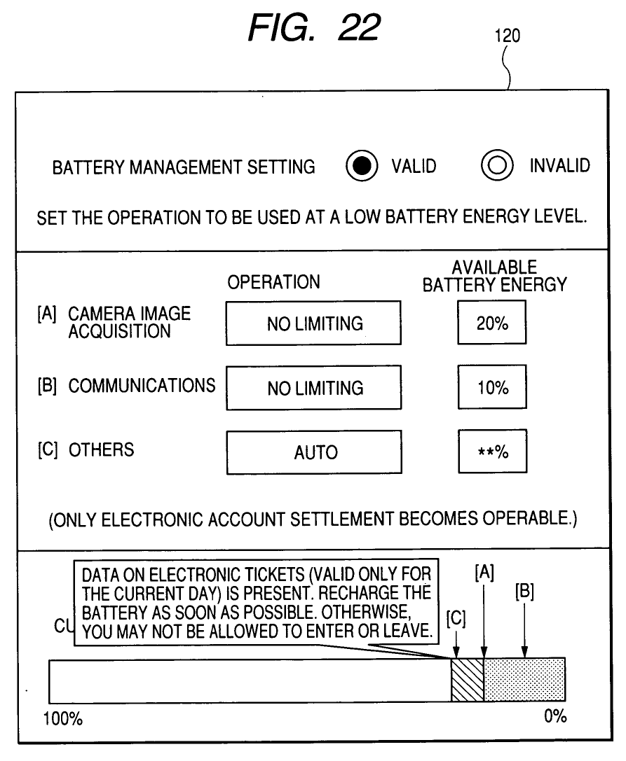

FIG. 22 is a diagram showing a sixth example of a setup screen for setting the threshold for operational limitation based on the quantity of battery energy left. The screen of FIG. 22 shows a state in which, since data for electronic account settlement is saved, a required quantity of battery energy must be reserved.

A message displayed above the meter indicating the quantity of battery energy left, at the bottom of the screen, indicates that even when the camera function and the communications function are in an operable condition, since electronic account settlement processing must be executed before the user can enter/leave using an electronic ticket, use of the battery is limited to prevent its residual energy from being consumed by execution of the camera function or the like.

Furthermore, when the quantity of battery energy left is very small as with the above, even if, during execution of an electronic ticket processing function in the conventional technology, a screen is to be displayed with a message or an effect sound in order to indicate whether the processing function has been performed to completion, supply of power to the video processor and voice processor circuits is stopped to perform adjustments shown in FIG. 19, so that only account settlement processing communication dares to be executed.

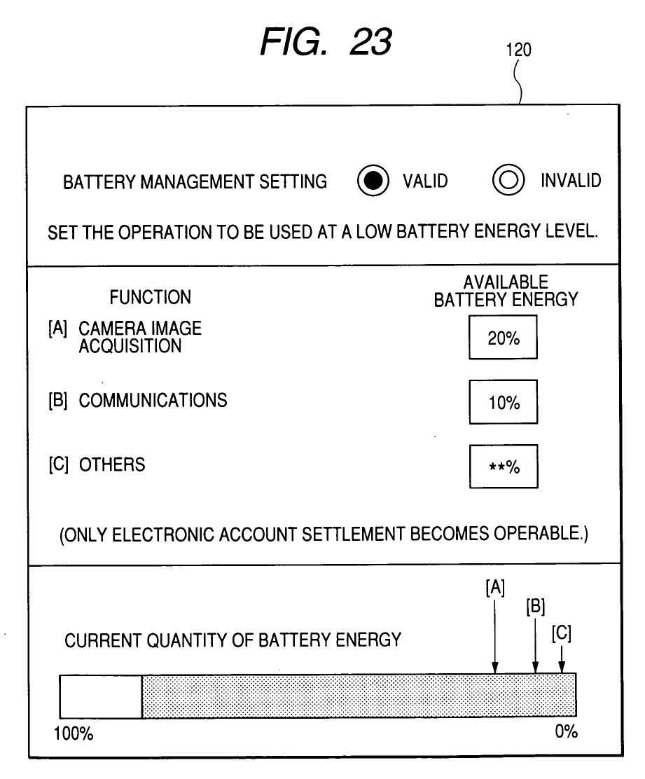

FIG. 23 is a diagram showing a seventh example of a setup screen for setting the threshold for operational limitation based on the quantity of battery energy left. In FIG. 23, the threshold for operational limitation based on the quantity of battery energy left can be set by clicking “Available battery energy” for each of the “Camera image acquisition”, “Communications”, and “Other functions” items and then as shown in FIG. 20, clicking the corresponding characters.

According to the present embodiment, an opportunity of using a high-priority function can be prevented from being missed by battery run-down. Alternatively, the operational limitation threshold for this purpose, based on the quantity of battery energy left, may be automatically set using an estimated operation time of a high-priority function. As another alternative method, selection of the operating state existing when the threshold for operational limitation based on the quantity of battery energy left is reached, and selection of the residual battery energy quantity to be defined as a threshold, may be set by user manual operations using the setup screen. As yet another alternative method, selection of the residual battery energy quantity value to be defined as a threshold, may be set for each function by user manual operations using the setup screen.

1. A portable information terminal device, comprising:
a plurality of processors each for performing a plurality of functions;
a power supply controller for detecting a residual quantity of battery energy from a battery or an external power supply and for controlling supply of electric power to said plurality of processors; and
a controller;
wherein said controller calculates a threshold of the battery energy capacity required for processing of information on a required function of said plurality of functions, changes the threshold according to a particular priority level of the required function in said plurality of functions, and notifies said power supply controller of a new threshold generated by the change, whereby said power supply controller controls supply of the power to said plurality of processors in accordance with the new threshold.

2. The portable information terminal device according to claim 1, wherein the threshold is changed automatically according to registered schedule data.

3. The portable information terminal device according to claim 1 or 2, wherein the threshold comprises a plurality of different thresholds and when one of the plural thresholds is changed, each of other thresholds is also changed.

4. The portable information terminal device according to claim 1, wherein the threshold is changed automatically according to learning about a usage tendency of a user.

5. The portable information terminal device according to claim 1, wherein a threshold of the battery energy capacity required for processing of information on a required function of said plurality of functions is changed by being selected from a setup screen.

6. A portable information terminal device, comprising:
a plurality of processors each for performing a plurality of functions;
a power supply controller for detecting a residual quantity of battery energy from a battery or an external power supply and for controlling supply of electric power to said plurality of processors; and
a controller;
wherein said controller automatically changes, according to registered schedule data, a threshold of the battery energy capacity required for processing of information on a required function of said plurality of functions, and notifies said power supply controller of a new threshold generated by the change, whereby said power supply controller controls supply of the power to the plurality of processors in accordance with the new threshold.

7. A portable information terminal device, comprising:
a plurality of processors each for performing a plurality of functions;
a power supply controller for detecting a residual quantity of battery energy from a battery or an external power supply and for controlling supply of electric power to said plurality of processors; and
a controller:
wherein said controller changes, in accordance with selection from a setup screen, a threshold of the battery energy capacity required for processing of information on a required function of said plurality of functions, and notifies said power supply controller of a new threshold generated by the change, whereby said power supply controller controls supply of the power to said plurality of processors in accordance with the new threshold.
